(19) United States
(12) Patent Application Publication
(10) Pub. No.: US 2006/0231975 A1
(43) Pub. Date: Oct. 19, 2006

(54) Method of producing metal mould cavities be means of ceramic and metal power sintering

(76) Inventor: Patrick Didier Teulet, route d' Ennezat (FR)

Correspondence Address: Ralph A. Dowell of DOWELL & DOWELL P.C., 2111 Eisenhower Ave, Suite 406, Alexandria, VA, 22314, US

(21) Appl. No.: 10/548,220

(22) PCT Filed: Mar. 1, 2004
(86) PCT No.: PCT/FR04/00466

§ 371 Date: May 9, 2006

(30) Foreign Application Priority Data
Mar. 4, 2003 (FR) 03/02642

(51) Int. Cl. B29C 33/40; B22F 3/105; C22B 1/00

(52) U.S. Cl. 264/225; 419/1; 264/219; 75/751

(57) ABSTRACT

The invention relates to a method of producing metal mould cavities by means of ceramic and metal powder sintering. According to the invention, once a ceramic powder has been selected from those available on the market in accordance with the production parameters, the inventive method comprises: a first step consisting in sintering the powder using a laser such as to produce a template (7, 8) which can be used directly, without any treatment, in the second step; and a second step consisting in pouring the metal powder around the template and sintering same in a furnace. The aforementioned method can be performed very quickly and cost effectively. The invention is particularly suitable for use in the production of cavities which are intended for gravity moulding or low- or high-pressure injection moulding.

The invention relates to a method of producing metal mould cavities by sintering a metal powder, or a mixture of metal powders, from a template.

In the domain of moulding metal materials, as well as in the domain of plastic injection, whether it be effected at low or at high pressure, it is known to make mould cavities by various techniques such as machining, by electro-erosion, by sintering metal powder in liquid phase with the aid of a laser, by gluing metal powder in the presence of resin with the aid of a laser, the powder being specific to the method, or by spraying metal powder and fusion by laser. U.S. Par. No. 4,314,399 also discloses a mould of which certain parts are made from ceramics.

These different techniques are relatively long to carry out as they require steps calling upon different technologies. They do not make it possible to use a template, also called master pattern, directly without a prior treatment of the latter.

In the same way, as a function of the complexity of the desired shapes of the cavity, surface state and precision, certain of these techniques may prove delicate to carry out. In certain cases, they are even inapplicable.

It is a more particular object of the invention to overcome these drawbacks by proposing a method of producing metal mould cavities which is simple, rapid to carry out and which allows the production of complex cavities both at the level of the desired shape and surface state and precision.

To that end, the invention relates to a method for producing at least a part of a metal mould cavity by sintering a metal powder, or a mixture of metal powders, from at least a part of a three-dimensional template, or master pattern, positioned in a casting frame, into which a metal powder, or a mixture of metal powders, is poured, before sintering in a furnace, the sintering being followed by the removal of the part of the template so as to free a volume forming at least a part of a cavity intended for moulding a piece, characterized in that the method comprises steps consisting in:

a) selecting a ceramic powder, or a mixture of ceramic powders, and a metal powder, or a mixture of metal powders, as a function of the production parameters;

b) depositing a homogeneous layer of small thickness of the ceramic powder selected, or of the mixture of ceramic powders selected, on a support of a sintering device in solid phase with the aid of a laser;

c) effecting a sintering of the layer of ceramic powder, or of the mixture of ceramic powders, without binding agent nor fluid, in pre-established laser scanning paths;

d) repeating steps b) then c) until the desired shape and dimensions of at least a part of the template are obtained;

e) positioning at least a part of the template, without retouching or treatment later than step d), in at least one casting frame in which a metal powder, or a mixture of metal powders, selected in step a) is poured, with a view to sintering thereof.

Thanks to the invention, a template is rapidly obtained from ceramic powder presenting a dimensional precision and a surface state allowing it to be used directly as master pattern in order to obtain a metal mould cavity. It is no longer necessary to carry out operations for preparation of the template before it is used such as, for example, a heat treatment and/or a retouch of its dimensions or its surface state.

Thanks to the invention, a metal powder, or metal powders, is/are used, making it possible to produce mould cavities made of a material compatible with the pieces to be produced by moulding, while taking into account the manufacturing servitudes of the latter.

According to advantageous but non-obligatory aspects of the invention, the method incorporates one or more of the following steps:

During step a), a ceramic powder, or a mixture of ceramic powders, is selected, of which the sintering temperature is higher than the sintering temperature of the metal powder, or of the mixture of metal powders, used for producing at least a part of the cavity. This sintering temperature of the ceramic powder, or of the mixture of ceramic powders, is advantageously greater by at least 10% than the sintering temperature of the metal powder, or of the mixture of metal powders.

During step a), a ceramic powder, or a mixture of ceramic powders, is selected from the products available on the market, for example, from aluminas, chemical compounds comprising alumina such as mullite, cordierite, alumina-zirconium mixtures or mixtures including carbides such as silicon carbide.

The passage of at least a part of the template between step d) and step e) is effected with the aid of a support mobile between the laser-assisted sintering device and a device for pouring the metal powder, or the mixture of metal powders.

During step e), a metal powder, or a mixture of metal powders, is conducted into at least one casting frame by a powder supply system such as a hopper, a pipe or a shovel, so as to distribute the powder, or the mixture of powders, uniformly in the whole of the filling volume of the frame.

During step e), there is positioned in at least one casting frame and in at least a part of the template, at least one conduit or channel adapted to allow cooling of the cavity, the passage of an ejector, the supply of matter to be moulded or the placing of an insert. This conduit is advantageously positioned before the end of pouring of the metal powder, or of the mixture of metal powders.

During step e), the density of the metal powder, or of the mixture of metal powders, poured into at least one frame is increased by compacting by vibration of the support bearing the frame and/or by vibration of the powder supply system and/or by placing the support and the powder supply system under depression. Such compacting is advantageously ensured by placing the enclosure under depression and vibrating the support and the powder supply system, followed by the addition of a fluid during the phase of pouring, under vibration, of the metal powder or of the mixture of metal powders.

After step e), finishing operations are effected on at least a part of the sintered metal cavity, for example by machining retouch or by polishing.

The invention also has for its object a template used in the method according to the invention, made of a ceramic material, from a ceramic powder, or a mixture of ceramic powders, by a method of sintering in solid phase without addition of binding agent and with the aid of a laser.

The sintering temperature of the ceramic material forming the template is greater than the sintering temperature of the metal powder, or of the mixture of metal powders, used for making a part of the cavity.

In addition to a greater rapidity and simplicity of the production operations, the supply of powders, both ceramic and metallic, is facilitated by the use of products obtained on the market. In this way it is easier to make cavities in adequateness with the matter of the piece to be moulded.

The invention will be more readily understood and other advantages thereof will appear more clearly in the light of the following description of the method for producing a metal cavity in accordance with the invention, given solely by way of example and made with reference to the accompanying drawings, in which:

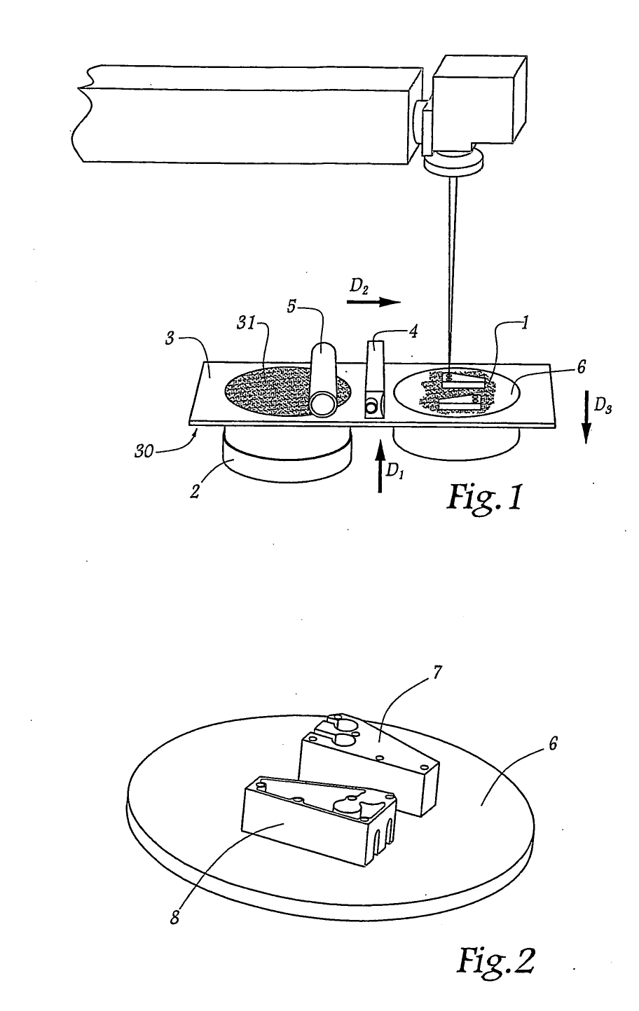

FIG. 1 is a general schematic view of a device for sintering, in solid phase with the aid of a laser, without binding agent, ceramic powder disposed in a layer of small thickness on a mobile table.

FIG. 2 is a general view of the two parts of the ceramic template of a hollow piece, obtained by sintering, disposed on a removable support and directly usable as master pattern.

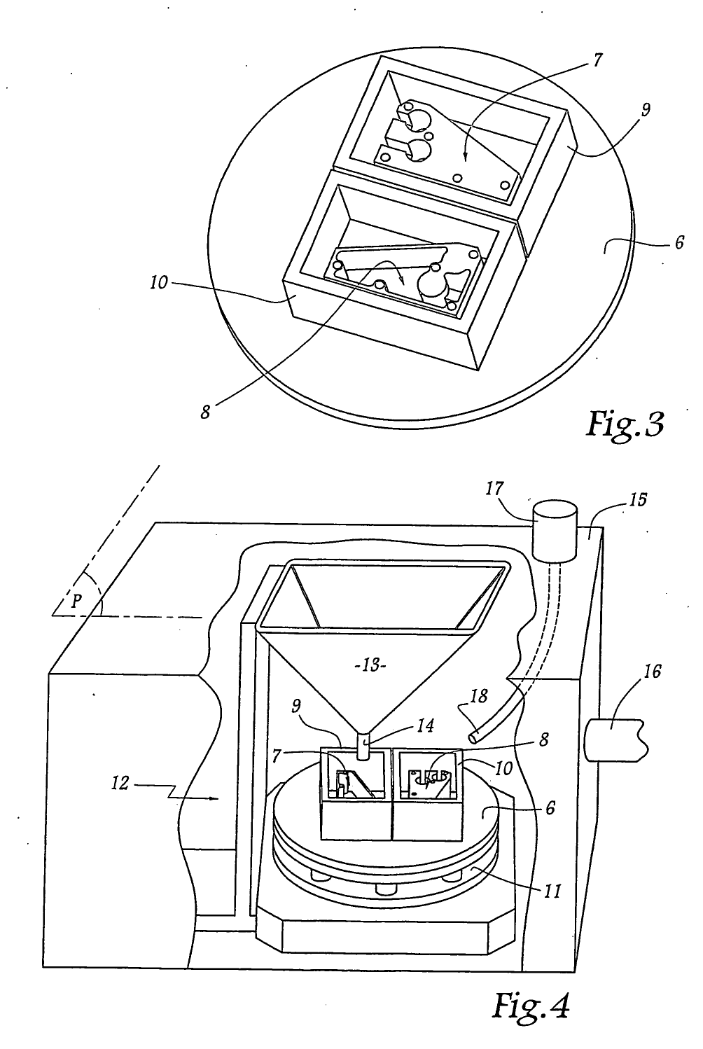

FIG. 3 is a plan view of the casting frames in place around the two parts of the template previously obtained, and

FIG. 4 is a general schematic view illustrating the operation of pouring, with the aid of a vibrating hopper, a metal powder into the casting frames, the removable support being positioned on a vibrating base, the whole being in an enclosure for placing under depression, shown schematically and with parts torn away.

The first step (not shown) of the method consists, from the specifications sheet of the cavity of the mould, on the one hand, and of the products to be moulded, on the other hand, in selecting a ceramic powder, or a mixture of ceramic powders, from the products available on the market. It is question, for example, of alumina and of mixtures including this product. One or more existing chemical compounds based on alumina and silica such as mullite, cordierite (alumina, silica and magnesia) or mixtures based on alumina and zirconium or based on alumina and carbides such as silicon carbide, are also used. “Custom-made” mixtures from commercialized powders are also used.

Particular care is taken to select this powder, or this mixture, as a function of its granulometry so as to be, at the end of the method, as close as possible to the surface state desired for a given cavity. This surface state depends, inter alia, on the porosity of the template. The higher the latter, the less the surface state is “good”. Similarly, the more the successive layers of powder that is sintered are thin and the more the surface state is close to that set in the specifications sheet.

Another important parameter is the sintering temperature of the ceramic powder, or of the mixture of ceramic powders, which must be higher than the sintering temperature of the metal powder, or of the mixture of metal powders, serving to make the cavity of the mould. This difference in sintering temperature makes it possible to preserve the characteristics of the template during the continuation of the method, and in particular to ensure a good mechanical and thermal resistance of the ceramic template while the metal powder is being sintered. This difference in temperature also ensures less shrinkage of the cavity while the metal powder, or the mixture of metal powders, is being sintered.

In order to preserve a simplicity and rapidity of implementation of the method, a sintering temperature of the ceramic powder higher by at least 10% than that of the metal powder is necessary.

During this initial phase, it is also important to estimate the dimensional shrinkages occurring during casting and sintering of the cavity in order to obtain a template which can be used directly and to have a minimum of finishing operations for the cavity. During this phase, the scanning paths of the laser are also defined. These paths define the passage of the laser beam above the layer of ceramic powder in order to sinter the latter, respecting the final geometry of the template and providing the definitive geometry of the cavity.

The sintering of this ceramic powder, or of this mixture of ceramic powders, distributed in successive layers of small thickness on a mobile work table is effected by a laser beam, without addition of binding agent, in accordance with the method of rapid prototyping described in WO 99/42421.

During this phase, the metal powder, or the mixture of metal powders, is also selected from those available on the market. This selection takes into account, in particular, the mechanical and thermal stresses to which the cavity is subjected when used during casting operations proper. This selection also takes into account other parameters known to the person skilled in the art such as the resistance to abrasion required for the cavity, the geometrical precision of the latter and the complexity of the shapes of the piece to be moulded.

FIG. 1 schematically illustrates the sintering of the ceramic material by laser. A layer 1 of ceramic powder of small thickness is deposited from a supply means on a table. This means is formed by a supply cylinder 2, located in the vicinity of a lower face 30 of a table 3. This cylinder is equipped with an internal piston (not shown) mobile in a direction D₁ globally perpendicular to the face 30. The cylinder 2 is located opposite an opening 31, of complementary shape, made in the table 3.

The layer 1 is spread with the aid of a member 4 and compacted with the aid of the roller 5 on a support 6 located beneath the laser. The member 4 and the roller 5 are mobile in a direction D₂ globally orthogonal to the direction D₁.

The smaller the thickness of the layer 1, the easier it is to have a homogeneous layer which may be easily sintered by the laser beam, in uniform manner over the whole thickness. In counterpart, the thinner the successive layers 1, the longer is the time to make the template. In practice, the compromise between the quality of the sintering of the ceramic powder and a relatively rapid production of the template is obtained from a thickness of about 10 microns.

As is shown in FIG. 1, the support 6 is mobile in a direction D₃ globally parallel to direction D₁ and oriented in opposite direction.

In the manner of a millefeuilles (multi-layered pastry), after each passage of the laser and sintering of a layer of ceramic powder, or of a mixture of ceramic powders, another layer is deposited on the support 6. This layer is in turn sintered. These unitary operations are repeated until two three-dimensional parts 7, 8 of a template with the desired dimensions are obtained. In this configuration, these two parts correspond to the two halves of a hollow piece to be moulded. For other forms of embodiment, the template may be in one piece or comprise a number of parts greater than two.

The operation following sintering of the template consists in evacuating, for example by blowing or by suction, the non-sintered ceramic powder present on the support 6.

The support 6 is removable with respect to the table 3 and it is easy to manipulate, generally by hand, taking into account the dimension and weight of the templates produced. The laser sintering device used has for example a support 6 of about 250 millimetres diameter and a useful working height of about 300 millimetres. This support 6 with the two parts 7, 8 of the template from which the excess of non-sintered ceramic powder has been cleared, as shown in FIG. 2, is brought into the work zone of a second device for making the metal cavity.

The finishing of such a template is sufficient for it to be directly usable in the continuation of the method, without needing to be retouched, particularly by operations of removal of binding agent, sintering by laser being effected without binding agent. Similarly, unlike a metal template, it is no longer necessary to subject it to a heat treatment.

As shown in FIG. 3, the following operation consists in positioning around the two parts 7, 8 two casting frames 9, 10 adapted to retain the metal powder, or the mixture of metal powders, before sintering thereof. It is necessary to centre in the same manner the two parts 7, 8 within the respective frames 9, 10, taking care that no external wall of the parts 7, 8 is in contact with an internal wall of the frame 9, 10 in which it is positioned.

These frames 9, 10 are in the form of chassis of sufficient dimensions and height to contain a part 7, 8 of the template completely. These casting frames 9, 10 are made of an inert matter, not undergoing any deformation during the final sintering.

In the following step shown in FIG. 4, the support 6, bearing the two casting frames 9, 10, is positioned on a base 1 1 of a device 12 intended for pouring the metal powder, or the mixture of metal powders, with which the cavity of the mould is formed.

This base 11 is surmounted by a device for supplying metal powder. As shown in FIG. 4, the supply device is preferably a hopper 13 provided in its lower part with a pipe 14 for evacuation of the powder. In a variant, it is possible to have a device formed by a supple pipe connected to an outside reservoir of metal powder, the passage of the powder being effected by gravity or by pumping.

The device 12 is located in an enclosure 15. This enclosure 15 is adapted to ensure the placing of the device 12 and the support 6 under depression. It comprises, in addition to a conduit 16 for evacuation of the air connected to a suction device (not shown), a tank 17 of fluid. This tank 17 makes it possible to fill the frames 9, 10 with a fluid, via a pipe 18.

The homogeneous distribution of the metal powder in the whole of the useful volume of each frame 9, 10 is ensured by vibration of the base 11 and of the hopper 13. The hopper 13 moves in a horizontal plane P in order to allow a homogeneous distribution of the powder in the frames. Such distribution is facilitated by the fact that the pipe 14 is articulated or supple.

Conduits or channels (not shown) are, if necessary, positioned during the distribution of the powder, or of the mixture of powders, in the frames. These conduits are placed in the frames 9, 10 and the parts 7, 8 of the template. During the sintering of the metal powder, or of the mixture of metal powders, they make it possible to form conduits in the cavity. These conduits are adapted to ensure the cooling of the latter during the moulding, the passage of ejector, the supply of matter to be moulded or the placing of an insert.

It is important, in order to guarantee the mechanical resistance of the sintered cavity, to effect a compacting of the metal powder, or of the mixture of metal powders, deposited in the frames before sintering.

This compacting is obtained by placing the enclosure 15 under depression and by vibrating the base 11. In this way, the evacuation of the air from parts 7, 8 of the template is promoted. A fluid which is inert with respect to the metal powder, or the mixture of metal powders, is then added into the frames 9, 10, while maintaining the vibrations.

This fluid, for example water or alcohol, makes it possible to evacuate the residual air captive in the porosities of the parts 7, 8 of the template. The powder, or the mixture, is poured under vibration into the frames 9, 10 until parts 7, 8 are covered.

In a later step (not shown), sintering of the metal powder is effected in a furnace. Such sintering is preferably effected in vacuo in order to improve the quality thereof by evacuation of the residual oxygen present in the powder, or the mixture of powders.

In a last step, the cavities thus produced are disengaged from the frames 9, 10 as well as the two parts 7, 8 of the template. Operations of finishing of the cavities are then carried out. These operations consist, for example, in machining passage of injectors, supply channels or vents if the latter were not made beforehand. If necessary, the finishing of the mould joints of the cavities and the polishing of certain surfaces of the cavities are also effected, if necessary.

Such a method is particularly adapted to the moulding of material by gravity, for example metal material and to the moulding by low pressure or high pressure injection. This method makes it possible to produce in masked time for the user both the template and the cavity of the mould. The use of powders, both ceramic ones for the template and metal for the cavity, which are found on the market, makes it possible to reduce the production costs of mould cavities while solving the problems of supply and storage of these powders.

The sintering temperatures of the powders, both ceramic and metal, are given by the supplier, but nonetheless it may happen that, for certain non-commercialised mixtures, these temperatures are not defined. They should then be determined experimentally with the aid of a test piece.

In another form of embodiment, and if the granulometry of the metal powder, or of the mixture of metal powders, allows this, the compacting is obtained without the addition of fluid, merely by placing under depression and vibration.

In another form of embodiment, only a part of the cavity is produced by this method, the other parts being made by other known methods.

1. Method for producing at least a part of a metal mould cavity by sintering a metal powder, or a mixture of metal powders, from at least a part of a three-dimensional template, or master pattern, positioned in a casting frame, into which a metal powder, or a mixture of metal powders, is poured, before sintering in a furnace, said sintering being followed by the removal of said part of the template so as to free a volume forming at least a part of a cavity intended for moulding a piece, characterized in that said method comprises steps consisting in:
a) selecting a ceramic powder, or a mixture of ceramic powders, and a metal powder, or a mixture of metal powders, as a function of the production parameters;
b) depositing a homogeneous layer (1) of small thickness of the ceramic powder selected, or of the mixture of ceramic powders selected, on a support (6) of a sintering device in solid phase with the aid of a laser;
c) effecting a sintering of said layer (1) of ceramic powder, or of the mixture of ceramic powders, without binding agent nor fluid, in pre-established laser scanning paths;
d) repeating steps b) then c) until the desired shape and dimensions of at least a part (7, 8) of the template are obtained;
e) positioning at least a part (7, 8) of the template, without retouching or treatment later than step d), in at least one casting frame (9, 10) in which a metal powder, or a mixture of metal powders, selected in step a) is poured, with a view to sintering thereof.

2. Method according to claim 1, characterized in that, during step a), a ceramic powder, or a mixture of ceramic powders, is selected, of which the sintering temperature is higher than the sintering temperature of the metal powder, or of the mixture of metal powders, used for producing at least a part of the cavity.

3. Method according to claim 2, characterized in that said sintering temperature of the ceramic powder, or of the mixture of ceramic powders, is greater by at least 10% than the sintering temperature of the metal powder, or of the mixture of metal powders.

4. Method according to claim 1, characterized in that, during step a), a ceramic powder, or a mixture of ceramic powders, is selected from the products available on the market, for example, from aluminas, chemical compounds comprising alumina such as mullite, cordierite, alumina-zirconium mixtures or mixtures including carbides such as silicon carbide.

5. Method according to claim 1, characterized in that the passage of at least a part of the template between step d) and step e) is effected with the aid of a support (6) mobile between the laser-assisted sintering device and a device (12) for pouring the metal powder, or the mixture of metal powders.

6. Method according to claim 1, characterized in that, during step e), a metal powder, or a mixture of metal powders, is conducted into at least one casting frame (9, 10) by a powder supply system such as a hopper (13), a pipe or a shovel, so as to distribute said powder, or said mixture of powders, uniformly in the whole of the filling volume of said frame (9, 10).

7. Method according to claim 1, characterized in that, during step e), there is positioned in at least one casting frame (9, 10) and in at least a part (7, 8) of the template, at least one conduit or channel adapted to allow cooling of the cavity, the passage of an ejector, the supply of matter to be moulded or the placing of an insert.

8. Method according to claim 7, characterized in that said conduit is positioned before the end of pouring of the metal powder, or of the mixture of metal powders.

9. Method according to claim 1, characterized in that, during step e), the density of the metal powder, or of the mixture of metal powders, poured into at least one frame (9, 10) is increased by compacting by vibration of the support (6) bearing said frame (9, 10) and/or by vibration of the powder supply system (13) and/or by placing said support (6) and said powder supply system (13) under depression.

10. Method according to claim 9, characterized in that such compacting is ensured by placing the enclosure (15) under depression and vibrating the support (6) and the powder supply system (13), followed by the addition of a fluid during the phase of pouring, under vibration, of the metal powder or of the mixture of metal powders.

11. Method according to claim 1, characterized in that, after step e), finishing operations are effected on at least a part of the sintered metal cavity, for example by machining retouch or by polishing.

12. Template used in a method for producing at least a part of a metal mould cavity according to claim 1, characterized in that it is made of a ceramic material, from a ceramic powder, or a mixture of ceramic powders, by a method of sintering in solid phase without addition of binding agent and with the aid of a laser.

13. Template according to claim 12, characterized in that the sintering temperature of the ceramic material forming said template is greater than the sintering temperature of the metal powder, or of the mixture of metal powders, used for making a part of the cavity.
